(19) United States
(12) Patent Application Publication
(10) Pub. No.: US 2002/0038753 A1
(43) Pub. Date: Apr. 4, 2002

(54) Apparatus and method for controlling segmented conveyor system

(76) Inventor: Valerian Ursu, Farmington, MI (US)

Correspondence Address: Edward I. Jorgenson, Philip G. Meyers Intellectual Property Law, P.C., 1009 Long Prairie Road, Suite 302, Flower Mound, TX, 75028, US

(21) Appl. No.: 09/751,644

(22) Filed: Dec. 29, 2000

Related U.S. Application Data
(60) Provisional application No. 60/173,860, filed on Dec. 30, 1999.

(51) Int. Cl. B65G 47/30

(52) U.S. Cl. 198/460.1

(57) ABSTRACT

A conveyor system includes a plurality of transit conveyors having a controller utilizing a logic scheme to selectively implement a time delay before authorizing transport of an article from an adjacent preceding conveyor to the transit conveyor, thereby maintaining and adjusting the gap between objects conveyed by the system. The invention includes a method of spacing the articles including (1) receiving an input signal with a controller associated with an individual transit conveyor indicating an article ready for transit from the preceding conveyor to the transit conveyor, (2) determining whether an object is present on the transit conveyor (3) generating a time delay when an article is present on the transit conveyor, and (4) transmitting an authorization signal to the preceding conveyor authorizing the transfer of an article from the preceding conveyor to the transit conveyor after the time delay has elapsed.

### RELATED APPLICATION

This application is a conversion of U.S. Provisional Application Serial No. 60/173,860, filed Dec. 30, 1999, upon which priority for this application is claim and the contents of which are incorporated herein for all purposes.

### TECHNICAL FIELD

The invention relates, in general, to a method and apparatus for controlling material handling systems and, in particular, to controlling conveyor systems comprised of individually controllable conveyor segments.

### BACKGROUND OF THE INVENTION

Material handling systems in the past have been designed of two basic types. One type is a conveyor transportation system that uses long conveyor lines, comprised typically of belt conveyors, to transport on one conveyance all objects to be carried. Another type of conveyor transportation system uses a network of smaller conveyors, comprised typically of belt or roller conveyors, that are individually controlled to transport on the various conveyors all objects tot be carried. The present invention relates to material handling systems of the second type.

### SUMMARY OF THE INVENTION

The present invention provides an improved method and apparatus for controlling a series of conveyors. In this system, the conveyor zone controllers will make a decision as to conveyor speed and timing based on an algorithm using the information from one photo eye sensors and inputs from the previous and next conveyor zones.

The system described herein is typically operated in one of two modes, a signal object or single tray mode when there is a need to have no more than one tray in a conveyor zone. Such applications include scales, scanning stations, and zones in front of or after certain special units. A disadvantage of this mode is that the throughput of a zone in this mode can be less than half that of a conveyor zone operating in the train mode. The second mode of operation is the train mode, typically used for long conveyor lines, which provides high transport speed but has the disadvantage of an increased tendency to create jams for busy conveyor lines having a lot of start and stop signals in a short period of time.

Depending upon the configuration of the line, units designed according to the present invention can be connected in different ways with or without other special units. Each conveyor in a multiple-conveyor transportation system forms an individually controllable conveyor zone. Each conveyor zone is longer than the object to be carried and typically is used to store and convey a single object along the conveyor network. At least one sensor, typically a photoelectric cell, and control logic are present in each conveyor zone. The control logic may be implemented in the form of programmed instructions present on a memory device in the zone or conveyor controller or may be implemented in a hard wired circuit.

The status of the sensors from a particular zone and adjacent zones preceding and following the particular zone are used by the controlling logic present in the particular zone to direct the flow of objects through the particular conveyor zone. Each conveyor zone has an electronic module containing circuitry for driving a motor, fixed or programable circuitry for evaluating the status of sensors, and circuitry for communicating with preceding and following zones. Additionally, general control and supervision over the entire conveyor network may be extended by providing circuitry for communication with a conveyor network controller.

The invention disclosed herein provides a new control algorithm that improves both the single tray mode and train mode, but especially the train mode. The algorithm increases both the speed and reliability of a conveyor line along its entire length. The algorithm incorporates a “gap regeneration” technique. This is done using a time delay for the authorization form one unit to the previous unit and a set/reset procedure for the signal coming from the previous unit.

The hardware boards and software programs traditionally employed for conveyor control typically incorporate special configuration devices such as dip switches and or software tools to configure a first, last or transit conveyor zone. These selections have traditionally been necessary to provide the proper functionality for a conveyor zone after a special unit (such as the first conveyor zone in the line), between other conveyor units (such as a transit conveyor) or before a special unit (such as the last conveyor zone in a line).

In units designed according to the present invention, the option to set a zone as a first zone, last zone or transit zone is eliminated by using the module just as a transit zone. The options of the first zone and last zone are implemented in a separate module for hardware or subroutine for software. This structure increases the flexibility and simplifies the manufacturing and maintenance of the units.

In one embodiment, the conveyor system includes a plurality of conveyors arranged end-to-end for transporting articles along the length thereof, including a plurality of transit conveyors, each disposed between adjacent conveyors. At least some of the transit conveyors include a controller for controlling the operation of the transit conveyor to receive conveyed articles from a preceding conveyor and convey the articles to a succeeding conveyor according to a predetermined logic scheme. Each controller maintains a selected spacing between articles conveyed from the transit conveyor to the succeeding conveyor by delaying transfer of articles to regenerate the spacing between articles which are spaced less than a predetermined distance apart in accordance with the logic scheme. In one embodiment, an adjacent preceding conveyor conveys an article to the transit conveyor only upon receiving an authorization from the transit conveyor controller and the transit conveyor transfers the article to the succeeding conveyor only upon receiving an authorization from the adjacent succeeding conveyor controller. The controller for each such transit conveyor selectively implements a time delay logic scheme to delay authorization for transport of an article from an adjacent preceding conveyor to the transit conveyor, thereby maintaining and adjusting the gap between objects conveyed by the system. Articles present on the conveyors are detected with sensors such as photo electric cells, proximity switches, contact switches, pressure switches or similar devices. In one embodiment, the predetermined logic scheme is embodied in a set of instructions programmed into a memory unit associated with the controller. In an alternate embodiment, the predetermined logic scheme is implemented with a hardwired circuit.

The invention also provides a method of controlling the spacing of articles conveyed on a conveyor system including a plurality of transit conveyors arranged in an end to end fashion between adjacent preceding and succeeding conveyors. The method includes the steps of (1) receiving an input signal with a transit conveyor controller associated with an individual transit conveyor, the signal indicating the presence of an article ready for transit from the preceding conveyor to the transit conveyor, (2) determining whether an object is present on the transit conveyor (3) generating a time delay when an article is present on the transit conveyor, and (4) transmitting an authorization signal to the preceding conveyor, the signal authorizing the transfer of an article from the preceding conveyor to the transit conveyor after the time delay has elapsed. In one embodiment of the method, each transit conveyor controller receives and transmits authorization signals to and from a preceding transit conveyor and a succeeding transit conveyor. The step of determining whether an article is present on the transit conveyor preferably comprises transmitting a signal from a sensor associated with the transit conveyor to the transit conveyor controller.

In another aspect the method may include the step of detecting whether a jam has occurred on the transit conveyor. The method may also include the step of detecting whether an article transferred to the transit conveyor has been conveyed across the conveyor in a predetermined period of time and generating an error signal when the object has not been conveyed across the conveyor within the time period.

### DESCRIPTION OF THE DRAWINGS

Referring now to the drawings wherein like reference numerals refer to the same and similar elements and steps,

FIG. 1 is a schematic representation of an authorization signal control system in accordance with one embodiment of the invention;

FIG. 2 is a schematic representation of an motor control system in accordance with one aspect of the invention;

FIG. 3 is a schematic representation of a jam error check logic control system in accordance with the invention;

FIG. 4 is a schematic representation of a lost article error check logic control system in accordance with the invention; and

FIG. 5 is a schematic representation of a conveyor system in accordance with the invention.

These and other aspects and advantages of the invention will be further described in the following Detailed Description.

### DETAILED DESCRIPTION

While the making and using of various embodiments of the invention are discussed in detail below, it should be appreciated that the invention provides many applicable inventive concepts which can be embodied in a wide variety of specific contexts. The specific embodiments discussed herein are merely illustrative of specific ways to make and use the invention and are not to delimit the scope of the invention as claimed.

Referring now to FIGS. 1 and 5, there is shown a schematic representation of a conveyor system 8 including a series of conveyors, 10, 12, and 14 for conveying articles 6. Each of conveyors 10, 12 and 14 are equipped with at least one photo electric cell 16, 18 and 20 respectively, (FIG. 5) and controllers 22, 24 and 26, each including a logic scheme represented by circuit 100 (FIG. 1) for implementing the basic algorithm and functional aspects of the conveyor zone control of the invention. As will be appreciated, the logic scheme represented by circuit 100 may be embodied as a set of instructions programmed into a memory unit (not shown) in controller 22. Photo electric cells 16, 18 and 20 detect the presence of conveyed articles on conveyors 10, 12, and 14 respectively, and provide inputs for circuit 100 represented in FIG. 1. It will be appreciated that devices other than photo sensors, i.e., pressure sensors, proximity sensors, contact sensors and similar devices for detecting the presence or absence of an article or object may be readily employed in the practice of the invention.

Turning now to FIG. 1, the circuit 100 presented therein represents control logic embodied in a controller for controlling a single zone conveyor. Circuit 100 is connected to the controls of a preceding unit through input 102 line and output line 104. Circuit 100 is similarly connected to the succeeding conveyor though input line 108 and output line106. If the logic embodied in circuit 100 is present and implemented as software, e.g., a set of programmed instructions on controller 22, input lines 102 and 108 along with output lines 104 and 106 represent transmission of software signals rather than the physical connections illustrated. In this case, the components illustrated in FIG. 1 represent functions and functionalities that would be embodied in a set of programmed instructions in a software embodiment.

When an object on the preceding conveyor 10 is ready to be transferred from the preceding conveyor to the intermediate conveyor 12, as sensed by photocell 16, the control logic for the preceding conveyor will generate a signal on input line 102 that is carried by line 110 to logic unit 112. Such a signal could comprise, for example, a rising or falling edge or signal amplitude, depending upon specific embodiment. In the embodiment illustrated in FIGS. 1 and 6, the signal on input line 102 is generated directly by photo electric cell 16. Logic unit 112, in response to an appropriate signal on line 102 will generate a pulse on line 114. Logic unit 112 comprises a negative front detection logic unit that detects a transition from TRUE to FALSE in a signal.

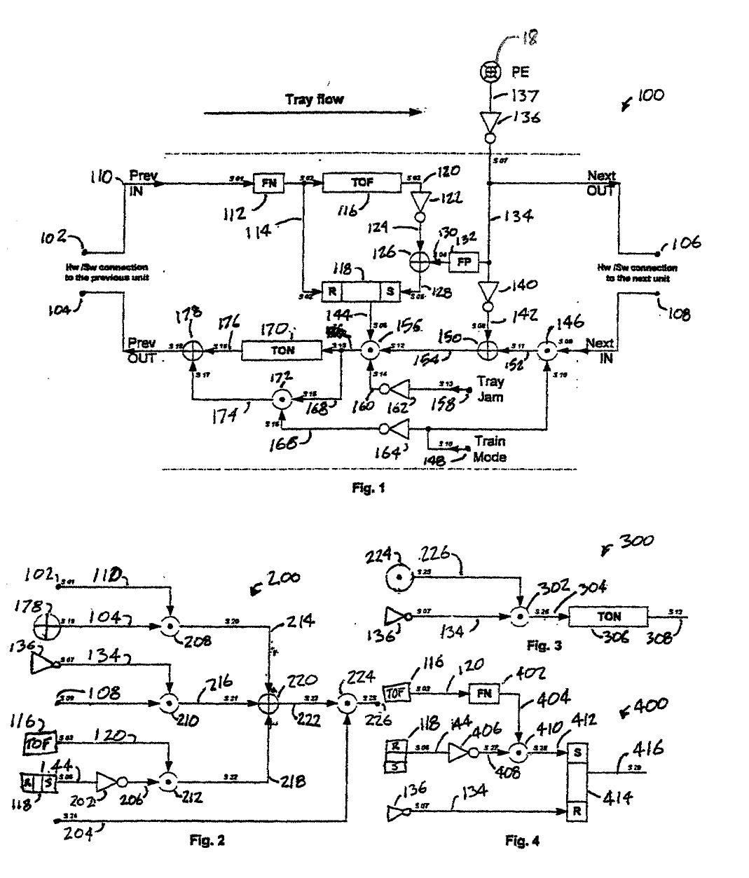

The output signal on line 114 from logic unit 112 is input to timer off delay unit 116 and to reset set/reset (bistable) logic unit 118. Timer off delay unit 116 is a timer that delays an “off” transition, i.e., from TRUE to FALSE. Timer off delay unit 116 thus delays setting the signal from logic unit 112 to an off condition. Upon receiving an appropriate input signal from logic unit 112, timer off delay unit 116 initiates a delay period after which an output TRUE signal is generated and communicated to inverter 122 on line 120, indicating that the timer has timed out. The FALSE output from inverter 122 is communicated to OR gate 126 over line 124. The signal from timer off unit is also transmitted to AND gate 212 in motor control circuit 200 (FIG. 2). As used herein the terms “AND gate” and “OR gate” incorporate devices and programmed instructions for implementing “AND” and “OR” boolean logic based upon the indicated inputs to the devices.

As noted above, conveyor 12 is equipped with a photo electric cell 18 for sensing the presence of a conveyed article on the conveyor. The output signal of photo electric cell 18 reflects the presence or absence of a conveyed article on conveyor 12. The output signal from photo electric cell 18 is input to inverter 136 over line 137 which, in turn, provides an output signal to the control circuit for conveyor 14 over line 106. The signal 137 from photo electric cell 18 is also transmitted to logic unit 132 and inverter 140 over line 134. Logic unit 132 is a positive from detection unit that detects a transition from FALSE to TRUE for an input signal.

The signal from photo electric cell 18 is TRUE if the photo electric cell is not blocked, i.e., if an article is not present. Thus, the output of OR gate 150 will be TRUE if either (1) an article is not present or (2) a TRUE signal is received from AND gate 146 indicating that an authorization signal is received from succeeding conveyor 14 over line 108 and a TRUE signal is received over line 148 indicating that conveyor 10 is in the train mode.

The output signal from logic unit 132 is the second signal input to OR gate 126, along with the inverted output of timer off delay unit 116. When either of the output signals from logic unit 132 or the output signal from timer off delay unit is TRUE, OR gate 126 transmits a TRUE signal to set set/reset logic unit 118 which in turn, transmits an auxiliary enable signal over line 144, depending upon the status of the inputs from logic units 112 and 126, respectively. Thus auxiliary enable signal transmitted over line 144 generated by set/reset logic unit 118 may be set by either a signal from photo electric cell 18 or a signal from the preceding conveyor 10, transmitted over line 102 and is transmitted to AND gate 156. Assuming that AND gate 156 is receiving a TRUE signal from inverter 162 over line 160, indicating no jam as determined by jam detection circuit 300 (FIG. 3), and a TRUE signal from OR gate 150 over line 154, then AND gate 156 transmits a TRUE signal to time delay unit 170 AND gate 172. Time delay unit 170 us a timer on delay, it delays the “on” transition, i.e., from FALSE to TRUE. If AND gate 172 is receiving a TRUE signal from inverter 164 over line 160, indicating that the “Train” mode is off, and a TRUE signal from AND gate 156, AND 172 gate transmits a TRUE signal to OR gate 178 over line 174. If OR gate 178 receives either a TRUE signal from AND gate 172 or a TRUE signal from time delay unit 170, indicating that the timer has timed out, OR gate 178 transmits a TRUE signal over line 104 to control unit 22 of preceding conveyor 10, indicating that an object may be conveyed to conveyor 12. The signal from OR gate 178 is also transmitted to AND gate 208 in motor control circuit 200 (FIG. 2), along with the input signal from preceding conveyor 10 over line 102.

As previously noted, control circuit 100 also receives an input signal from succeeding conveyor 14 over input line 108. The signal received over line 108 is input to AND gate 146, along with the train mode input signal 148. If both of these signals are true then AND gate 146 outputs a true signal 152 to OR gate 150, that also receives signal 142 from inverter 140. If either of these signals are TRUE, then OR gate 150 outputs a TRUE signal to AND gate 156.

A TRUE to FALSE (negative front) signal on line 104, indicating the presence of article on conveyor 10 awaiting transfer to conveyor 12, will result in a TRUE signal being transmitted from logic unit 112 over line 114 to set/reset logic unit 118. The signal from logic unit 114 is also transmitted via timer off delay 116, inverter 122 and OR gate 126 to set logic unit 118 to set back the auxiliary enable signal 144. The auxiliary enable signal from set/reset logic unit 118 may also be set by the inverted signal from photo electric cell 18 as transmitted through inverter 136, logic unit 132 (positive front detection) and OR gate 126. The transmission of auxiliary enable signal is conditioned upon AND gate 156 receiving a TRUE signal from inverter 162 over line 160, indicating that a jam is not present and receiving a TRUE signal 154 from OR gate 150.

The output of AND gate 156 will be TRUE when (1) no tray jam is detected as indicated by the signal received over line 160, (2) AND gate 156 is receiving a TRUE signal from set/reset logic unit 118 over line 144, and (3) AND gate 156 is receiving a TRUE signal over line 154 from OR gate 150.

The timing of the signal transmitted to preceding conveyor 10 is determined by whether conveyor 12 is set in the train mode. If conveyor 12 is set in the train mode, inverter 164 will communicate a FALSE signal over line 166 to AND gate 172, preventing a TRUE signal transmitted over line 168 from reaching OR gate 178 in output line 104. In this case, assuming that there is a TRUE signal on line 168, the TRUE signal on line 168 will only be transmitted after the time delay on unit 170 times out, outputting a TRUE signal over line 176 to OR gate 178, which in turn then transmits a TRUE, or authorization signal over output line 104.

Alternatively, if conveyor 12 is not set in the train mode, but rather is set in a single tray or single article mode, the output of inverter 164 will be TRUE, resulting in the transmission of a TRUE or authorization signal by OR gate 178 over output line 104.

As will be appreciated, an auxiliary enable or authorization signal over line 104 may be generated in two different ways. If conveyor 12 is in the train conveying mode, the combination of (1) a TRUE signal from set/reset unit 118, (2) a TRUE signal from OR gate 150, indicating either an authorization signal from conveyor 14 or a TRUE signal from photo electric cell 18 indicating no article present, and, (3) a TRUE signal from inverter 162, indicating the absence of a jam, will result in a TRUE signal being generated by AND gate 156 and transmitted to timer on delay unit 170. In this case, AND gate will receive a FALSE signal from inverter 164, blocking transmission of a signal around timer on delay unit 170 on line 174. After timer on delay unit 170 has timed out, an enable or authorization signal will be generated and transmitted via line 176 and OR gate 178 over line 104.

Alternatively, if conveyor 12 is in the single article conveying mode, a combination of (1) a TRUE signal from set/reset unit 118, (2) a TRUE signal from OR gate 150, indicating a TRUE signal from photo electric cell 18 indicating no article present, and, (3) a TRUE signal from inverter 162, indicating the absence of a jam, will result in a TRUE signal being generated by AND gate 156 and transmitted to AND gate 172. Since the conveyor is in the single article conveying mode, the inverted signal from inverter 164 will be TRUE, allowing transmission of a TRUE or authorization signal on line 174 through OR gate 178 to preceding conveyor 10 on line 104 without a time delay.

As will be appreciated, control circuit 100 implements a “gap regeneration” control that maintains the gap between articles conveyed along conveyors 10, 12 and 14.

The gap regeneration is accomplished applying a set/reset procedure to the signal received from the preceding conveyor in combination with a time delay applied to the authorization signal sent to the preceding conveyor. The actual values of the time delay will, of course, vary with the specific application depending upon the speed at which the conveyors are operated, the desired size of the gap between conveyed articles, the physical dimensions of the conveyed articles and other application specific criteria. Additionally, as illustrated, the conveyor system utilizes belt conveyors, however, it will be appreciated that the inventive concepts described herein are equally applicable to systems employing other types of conveyors including, without limitation, powered roller type conveyors, chain conveyors and segmented tray type conveyors.

It will also be appreciated that circuit 100 incorporates and illustrates those portions of the system of the invention relating to the interconnections and communications between control units for preceding and succeeding conveyors. In particular, it will be appreciated that the control circuit 100 will not require modification for use on an end conveyor unit, i.e., the first or last conveyor in a series of conveyor units.

Turning now to FIG. 2 there is illustrated a diagram for the conveyor motor logic in the form of a circuit 200. The signal present on line 226 is the motor on/off output for the circuit 200. Circuit 200 receives as inputs the input signal on line 102 from preceding conveyor 10 on line 110 and the output of OR gate 178 though AND gate 208. The signal from inverter 136 is received on line 134 and input to AND gate 210 along with the output signal 108 from the succeeding conveyor. The signal from timer off delay unit 116 is input to AND gate 212 via line 120. The signal from set/reset logic device 118 is invert by inverter 202 and input to AND gate 212 via line 206.

The inputs from AND gates 208, 210 and 212 are input to OR gate 220. The signal from OR gate 220, along with an auxiliary status signal on line 204 are input into and gate 224. The signal on line 204 represents the status of auxiliary conditions, i.e., safety devices, over current protection devices, and similar conditions that must be satisfied prior to setting the motor on/off signal to on. Thus, a “motor on” signal will be transmitted from AND gate 224 on line 226 when the signal on line 204 is TRUE and at least one of the following set of conditions are met: (1) a TRUE signal is received on line 102 from preceding conveyor 10, and a TRUE signal is transmitted on line 104 from OR gate 178 as described above, i.e., the presence of authorization signals both too and from the preceding conveyor (2) a TRUE signal is transmitted from inverter 136 and a TRUE signal is transmitted on input line 108 from succeeding conveyor 14, i.e., the presence of authorization signals both to and from the succeeding conveyor 14 and (3) a TRUE signal is received on line 120 from timer off device 116 and a TRUE signal is transmitted on line 144 from set/reset logic device 118, i.e., when the timer off and a reset condition is not present.

The control system of the invention also contains provisions for detecting and signaling two error conditions, a jam error and a lost article error. The logic for the jam error is schematically represented circuit 300 of FIG. 3. Circuit 300 receives the motor on signal from AND gate 224 on line 226 which is input to AND gate 302. Circuit 300 also receives the signal from inverter 136 on line 134, indicating the presence of an article on conveyor 12. When both the “motor on” and “article present” signals are TRUE, AND gate 302 will transmit a TRUE signal to timer on delay device 306, which after will transmit a TRUE output on line 308 after the timer times out. Timer delay device 306 is a timer on delay unit, it delays the “on” transition, e.g., from FALSE to TRUE.

A change of state of the signal on line 304 from FALSE to TRUE resets timer on delay device 306, beginning a timed interval. If, at the end of the timed interval, the input signals on lines 226 and 134 remain TRUE, the output of timer on delay device 306 is set to true on line 308, indicating an error condition. A TRUE output on line 308 reflects the condition where the conveyor motor has been energized for a period equal to the time interval set by timer on delay device 306 while there has been no detectable change in part position, indicating that a jam of some sort has occurred. In the illustrated embodiment, the output of timer on delay device 306 is also input on line 158 of circuit 100.

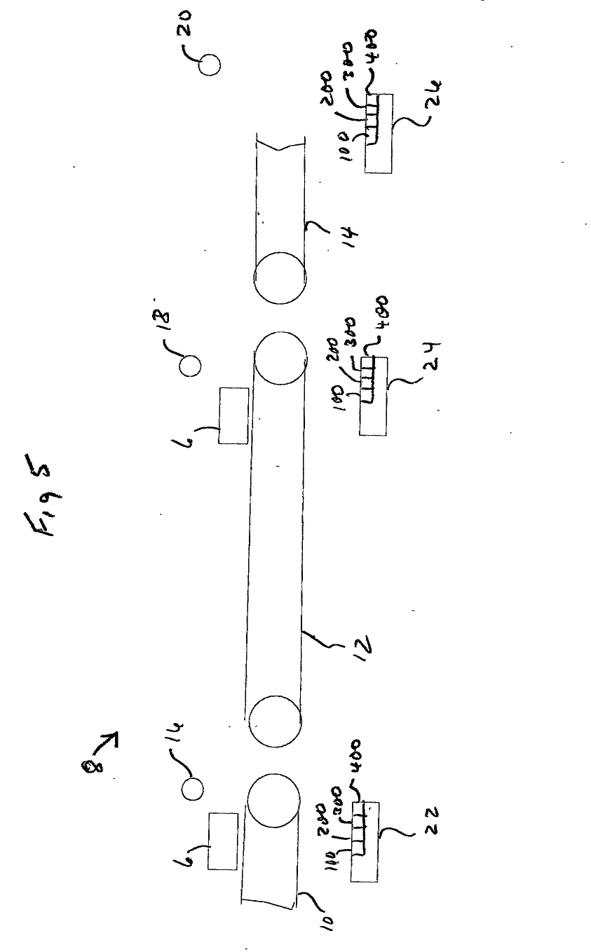

Detection and signaling of the second error condition, a lost article is provided by the logic represented by circuit 400 of FIG. 4. A TRUE output on line 120 from timer off device 116 is input to logic device 402 which generates a pulse output to AND gate 410 over line 404. Also input to AND gate 410 is the inverted output from logic set/reset unit 118 on line 408 from inverter 406. The output from AND gate 410 is directed to set/reset logic unit 414 over line 412. The output from inverter 136 is also input to set/reset logic unit 414. In operation, the set/reset unit is set with signal from timer off delay unit 116 when set/reset unit 118 is reset and transmitted via AND gate 410. If set/reset unit 414 is not reset by a signal from photo electric cell 18, inverted by inverter 136, before timer off logic unit 116 times out, set/rest unit 414 will generate a TRUE signal, indicating that an article has entered the conveyor zone, i.e., has been transferred onto conveyor 12, but has failed to reach the photocell within the expected period of time.

Although certain embodiments of the invention have been described for the purpose of illustration, numerous changes and modifications will become apparent to those skilled in the art without departing from the spirit and scope of the invention. Such changes or modifications are incorporated within the scope of the invention as defined in the appended claims.

1. A conveyor system comprising:
a plurality of conveyors arranged end-to-end for transporting articles along the length thereof, including a plurality of transit conveyors, each transit conveyor being disposed between adjacent conveyors;
at least some of the transit conveyors further comprising a controller, the controller controlling the operation of each such transit conveyor to receive conveyed articles from a preceding conveyor and convey the articles to a succeeding conveyor according to a predetermined logic scheme;
each controller maintaining selected spacing between articles conveyed from the transit conveyor to the succeeding conveyor, the controller delaying transfer of articles to regenerate the spacing between articles which are spaced less than a predetermined distance apart in accordance with the logic scheme.

2. The conveyor system of claim 1 wherein the adjacent preceding conveyor conveys an article to the transit conveyor only upon receiving an authorization from the transit conveyor controller.

3. The conveyor system of claim 1 wherein the transit conveyor conveys an article to the adjacent succeeding conveyor only upon receiving an authorization from the adjacent succeeding conveyor controller.

4. The conveyor system of claim 1 wherein the controller for each such transit conveyor implements a time delay logic scheme to delay authorization for transport of an article from an adjacent preceding conveyor to the transit conveyor.

5. The conveyor system of claim 1 where each transit conveyor includes at least one sensor for detecting the presence of an object to be conveyed.

6. The conveyor system of claim 5 wherein the sensor is a photo electric cell.

7. The conveyor system of claim 1 wherein the predetermined logic scheme comprises a set of set of instructions programmed into a memory unit associated with the controller.

8. The conveyor system of claim 1 wherein the controller further comprises a hard wired circuit for implementing the predetermined logic scheme.

9. A method of controlling the spacing of articles conveyed on a conveyor system including a plurality of transit conveyors, each transit conveyor arranged in an end to end fashion between adjacent preceding and succeeding conveyors, the method comprising:
receiving an input signal with a transit conveyor controller associated with an individual transit conveyor, the signal indicating the presence of an article ready for transit from the preceding conveyor to the transit conveyor;
determining whether an object is present on the transit conveyor;
generating a time delay when an article is present on the transit conveyor; and
transmitting an authorization signal to the preceding conveyor, the signal authorizing the transfer of an article from the preceding conveyor to the transit conveyor after the time delay has elapsed.

10. The method of claim 9 wherein each transit conveyor controller receives and transmits authorization signals to and from a preceding transit conveyor and a succeeding transit conveyor.

11. The method of claim 9 wherein the step of determining whether an article is present on the transit conveyor further comprises transmitting a signal from a sensor associated with the transit conveyor to the transit conveyor controller.

12. The method of claim 11 wherein the sensor is a photo electric cell.

13. The method of claim 9 further comprising the step of detecting whether a jam has occurred on the transit conveyor.

14. The method of claim 9 further comprising the step of detecting whether an article transferred to the transit conveyor has been conveyed across the conveyor.

15. The method of claim 14 further comprising the step of generating an error signal when an article transferred from a preceding conveyor has not been conveyed across the transit conveyor within a predetermined time period.
A method
at least some of the transit conveyors further comprising a controller, the controller controlling the operation of each such transit conveyor to receive conveyed articles from a preceding conveyor and convey the articles to a succeeding conveyor according to a predetermined logic scheme;
each controller maintaining selected spacing between articles conveyed from the transit conveyor to the succeeding conveyor, the controller delaying transfer of articles to regenerate the spacing between articles which are spaced less than a predetermined distance apart in accordance with the logic scheme.
